(19) United States
(12) Patent Application Publication
(10) Pub. No.: US 2023/0246230 A1
(43) Pub. Date: Aug. 3, 2023

(54) ELECTROLYTES FOR LITHIUM BATTERIES

(71) Applicant: UCHICAGO ARGONNE, LLC, Chicago, IL (US)

(72) Inventors: Chi Cheung Su, Bolingbrook, IL (US); Khalil Amine, Oakbrook, IL (US)

(73) Assignee: UCHICAGO ARGONNE, LLC, Chicago, IL (US)

(21) Appl. No.: 17/588,740

(22) Filed: Jan. 31, 2022

(51) Int. Cl. H01M 10/0565; H01M 4/525; H01M 4/58; H01M 10/052; H01M 4/38; H01M 4/62

(52) U.S. Cl. CPC H01M 10/0565; H01M 4/525; H01M 4/58; H01M 10/052; H01M 4/382; H01M 4/625; H01M 2300/0082; H01M 2300/0085

(57) ABSTRACT

An electrochemical cell includes a cathode of oxygen or a metal oxide; an anode being made of lithium metal; and an electrolyte including a lithium sulfonylimide salt, a terminally fluorinated glycol ether, and optionally an electrolyte additive, a aprotic gel polymer, or a mixture thereof.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to lithium rechargeable batteries. More particularly the technology relates to the use of short-chain terminally fluorinated glycol ethers and lithium fluorosulfonylimide salt in an electrochemical cell having a metallic lithium anode.

### SUMMARY

In one aspect, an electrochemical cell is provided having a cathode comprising oxygen or a metal oxide; an anode comprising silicon, conductive carbon, lithium metal, or a combination of any two or more thereof; a separator; and an electrolyte comprising a lithium fluorosulfonylimide salt, a terminally fluorinated glycol ether, and optionally an electrolyte additive, an aprotic gel polymer, or a mixture thereof. In some embodiments, the electrochemical cell is a lithium battery.

### BRIEF DESCRIPTION OF THE DRAWINGS

FIG. 1 is a graph of cycling performance of Li∥symmetric cells using different LiPF₆ based electrolytes, according to Example 2.

FIG. 2 is a graph of cycling performance of symmetric cells using different lithium bis(fluoromethanesulfonyl)imide (“LiFSI”) and LiPF₆ based electrolytes, according to Example 4.

FIG. 3 is a graph of cycling performance of Li∥Li symmetric cells using electrolytes with LiFSI or lithium bis(trifluoromethanesulfonyl)imide (“LiTFSI dissolved in FDG, according to Example 5.

FIGS. 4A-4B. FIG. 4A is a graph of capacity retention. FIG. 4B illustrates the corresponding Coulombic efficiency of Li∥LiNi_{0.8}Mn_{0.1}Co_{0.1}O₂ Mn_{0.1}O₂ (NMC811) cell using different electrolytes cycling at 2.5V-4.3V, according to Example 6.

FIGS. 5A-5B. FIG. 5A is a graph of capacity retention. FIG. 5B illustrates the corresponding Coulombic efficiency of Li∥LiNi_{0.8}Mn_{0.1}Co_{0.1}O₂ (NMC811) cell using different electrolytes cycling at 3.0V-4.4V, according to Example 7.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. It should be noted that unless otherwise indicated any alkyl, alkenyl, alkynyl, aryl, ether, ester, or the like may be substituted, whether indicated as substituted or not. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

It has been found that the electrochemical performance of lithium metal batteries (i.e. where the anode contains lithium metal, as a foil or sheet) is significantly improved where a short-chain terminally fluorinated glycol ether(s) is used in the electrolytes as compared to similar cells using non-fluorinate glycol ether(s) or even fluorinated glycol ether(s) with longer fluorinated alky chains. In some embodiments, the the incorporation of a lithium fluorosulfonylimide salt coupled with the short-chain terminally fluorinated glycol ether provides a synergistic effect with regard to the stabilization of the lithium metal batteries, when compared to other batteries that include other salts (e.g. LiPF₆) or even the longer chain terminally fluorinated glycol ethers.

In one aspect, an electrochemical cell includes a cathode comprising oxygen or a metal oxide; an anode comprising lithium metal; and an electrolyte comprising a lithium fluorosulfonylimide salt, a terminally fluorinated glycol ether, and optionally an electrolyte additive, an aprotic gel polymer, or a mixture thereof. In some embodiments, the anode may further include silicon or a conductive carbon. In some embodiments, the terminally fluorinated glycol ether is a short-chain terminally fluorinated glycol ether.

The electrolyte includes at least a solvent and the salt, where the solvent includes the terminally fluorinated glycol ether. The solvent of the electrolyte may include greater than 50 wt % of the terminally fluorinated glycol ether. For example, the electrolyte may include greater than 75 wt % of the terminally fluorinated glycol ether, greater than 90 wt % of the terminally fluorinated glycol ether, or greater than 95 wt % of the terminally fluorinated glycol ether. In some embodiments, the solvent of the electrolyte is only a short-chain terminally fluorinated glycol ether. In some embodiments, the electrolyte consists essentially of the lithium sulfonylimide salt, the terminally fluorinated glycol ether, and optionally the electrolyte additive.

In some embodiments, the fluorinated glycol ether is a compound is represented by Formula I: R¹(O(CH₂)ₘ)ₓ(O(CH₂)ₙ)_{y}OR² (I). In Formula I, R¹ is a fluorinated alkyl; R² is a fluorinated alkyl; m and n are each independently 1, 2, or 3; and x and y are independently 0, 1, 2, 3, with the proviso that both x and y are not 0 and x+y≤3. In some embodiments, one of R¹ and R² is a fluorinated alkyl having at least two fluorine atoms. In some embodiments, one of R¹ and R² is a fluorinated alkyl having at least three fluorine atoms.

In some embodiments, R¹ is —(CH₂)_{q}(CR⁴R⁵)ₚC(R³)₃; R² is —(CH₂)ᵥ(CR^{4′}R^{5′})_{w}C(R^{3′})₃; R³, R⁴, and R⁵ are each independently H or F, with the proviso that at least one of R³, R⁴, and R⁵ is F; R^{3′}, R^{4′}, and R^{5′} are each independently H or F, with the proviso that at least one of R^{3′}, R^{4′}, and R^{5′} is F; q is 0, 1, 2, or 3; v is 0, 1, 2, or 3; p is 0, 1, 2, 3, 4, 5, or 6; and w is 0, 1, 2, 3, 4, 5, or 6. In some embodiments, R³ is F; R⁴ and R⁵ are H; q is 1 or 2; and p is 0. In some embodiments, R^{3′} is F; R^{4′} and R^{5′} are H; v is 1 or 2; and w is 0.

In some embodiments, R¹ is —(CH₂)_{q}(CR⁴R⁵)ₚC(R³)₃; R² is —(CH₂)ᵥ(CR^{4′}R^{5′})_{w}C(R^{3′})₃; R³, R⁴, and R⁵ are each independently H or F, with the proviso that at least one of R³, R⁴, and R⁵ is F; R^{3′}, R^{4′}, and R^{5′} are each independently H or F, with the proviso that at least one of R^{3′}, R^{4′}, and R^{5′} is F; y is 0; x is 2 or ₃; q is 0, 1, 2, or 3; v is 0, 1, 2, or 3; p is 0, 1, 2, 3, 4, 5, or 6; and w is 0, 1, 2, 3, 4, 5, or 6. In some embodiments, y is 0; and x is 2 or 3. In some embodiments, R¹ is —(CH₂)_{q}(CH₂)ₚC(R³)₃; R² is —(CH₂)ᵥ(CH₂)_{w}C(R^{3′})₃; q is 1; v is 1; p is 0; w is 0; R³ is F; R^{3′} is F; y is 0; x is 2 or 3; and m is 2.

In some embodiments, m is 1. In some embodiments, m is 2. In some embodiments, m is 3. In some embodiments, n is 1. In some embodiments, n is 2. In some embodiments, n is 3.

In some embodiments, x is 0. In some embodiments, x is 1. In some embodiments, x is 2. In some embodiments, x is 3. In some embodiments, y is 0. In some embodiments, y is 1. In some embodiments, y is 2. In some embodiments, y is 3.

In some embodiments, q is 0. In some embodiments, q is 1. In some embodiments, q is 2. In some embodiments, q is 3. In some embodiments, p is 0. In some embodiments, p is 1. In some embodiments, p is 2. In some embodiments, p is 3. In some embodiments, p is 4. In some embodiments, p is 5. In some embodiments, p is 6.

In some embodiments, v is 0. In some embodiments, v is 1. In some embodiments, v is 2. In some embodiments, v is 3. In some embodiments, w is 0. In some embodiments, w is 1. In some embodiments, w is 2. In some embodiments, w is 3. In some embodiments, w is 4. In some embodiments, w is 5. In some embodiments, w is 6.

In some embodiments, R³ is H. In some embodiments, R³ is F. In some embodiments, R⁴ is H. In some embodiments, R⁴ is F. In some embodiments, R⁵ is H. In some embodiments, R⁵ is F.

In some embodiments, R^{3′} is H. In some embodiments, R^{3′} is F. In some embodiments, R^{4′} is H. In some embodiments, R^{4′} is F. In some embodiments, R^{5′} is H. In some embodiments, R^{5′} is F.

Illustrative examples of the short-chain terminally fluorinated glycol ether(s) includes one or more of:

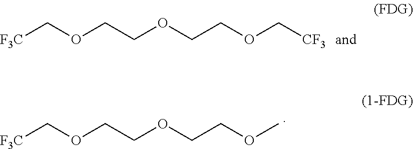 [SMILES: FC(F)(F)COCCOCCOCC(F)(F)F ; COCCOCCOCC(F)(F)F]

In some embodiments, the lithium sulfonylimide salt includes LiN(SO₂F)₂; LiN(SO₂CF₃)₂; LiN(SO₂C₂F₅)₂; Li(SO₂F)N(SO₂CF₃); Li(SO₂F)N(SO₂CH₃); Li(SO₂F)N(SO₂C₂H₅); Li(SO₂F)N(SO₂C₂F₅); Li(SO₂F)N(SO₂CHF₂); Li(SO₂F)N(SO₂CH₂F); Li(SO₂F)N(SO₂CH₂CF₃); Li(SO₂F)N(SO₂CH₂CHF₂); Li(SO₂F)N(SO₂CHFCH₃); Li(SO₂F)N(SO₂CHFCF₃); Li(SO₂F)N(SO₂CHFCHF₂); Li(SO₂F)N(SO₂CHFCH₂F); Li(SO₂F)N(SO₂CF₂CH₃); Li(SO₂F)N(SO₂CF₂CF₃); Li(SO₂F)N(SO₂CF₂CHF₂); Li(SO₂F)N(SO₂CF₂CH₂F); Li(SO₂CF₃)N(SO₂CH₃); Li(SO₂CF₃)N(SO₂CHF₂); Li(SO₂CF₃)N(SO₂CH₂F); Li(SO₂CF₃)N(SO₂CH₂CF₃), or a mixture of any two or more thereof. In some embodiments, the lithium sulfonylimide salt includes LiFSI.

The electrochemical cells described herein may also include in the electrolytes, an electrolyte stabilizing additive that may be LiBF₂(C₂O₄), LiB(C₂O₄)₂, LiPF₂(C₂O₄)₂, LiPF₄(C₂O₄), LiPF₆, LiAsF₆, CsF, CsPF₆, Li₂(B₁₂X₁₂₋ᵢHᵢ), Li₂(B₁₀X_{10-i′}H_{i′}), or a mixture of any two or more thereof. In such additives, each X is independently at each occurrence a halogen, i is an integer from 0 to 12 and i′ is an integer from 0 to 10. In some embodiments, the electrolyte may also contain an electrode stabilizing additive such as but not limited to LiB(C₂O₄)₂, LiBF₂(C₂O₄)₂, 1,3,2-dioxathiolane-2,2-dioxide, ethylene sulfite, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydropyran, 3,9-diethylidene-2,4,8-trioxaspiro[5,5]undecane, 2-ethylidene-5-vinyl-[1,3]dioxane, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof. The electrolyte additive may be present at a concentration of less than about 5 wt %. The electrolyte additive may be present at a concentration of from about 0.01 wt % to about 5 wt %.

In further embodiments, the electrolyte may further include an aprotic gel polymer. For example, mixtures of poly(ethylene oxide) (PEO) with lithium salts and an organic aprotic solvent may be used.

In some embodiments, the electrolyte may also include a redox shuttle material. The shuttle, if present, will have an electrochemical potential above the positive electrode's maximum normal operating potential. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano-2-(trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂(B₁₂X₁₂₋ᵢHᵢ), Li₂(B₁₀X_{10-I′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄. The electrolyte additive may be present in the electrolyte in an amount of about 1% to about 10% by weight or by volume. This includes an amount of about 1% to about 8% by weight or by volume, about 1% to about 6% by weight or by volume, about 1% to about 4% by weight or by volume, or about 1% to about 3% by weight or by volume. In some embodiments, the electrolyte additive is present in the electrolyte in an amount of about 1, 2, 3, 4, 5, 6, 7, 8, 9, or 10% by weight or by volume.

Also as noted herein, the electrolyte may further include electrolyte additives to help stabilize the electrode, assist in include, but are not limited to LiBF₂(C₂O₄, LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ); Li₂(B_{10-i′}H_{i′}), or a mixture of any two or more thereof. As set forth, each X is independently a halogen, each i is an integer from 0 to 12 and each i′ is an integer from 0 to 10. The electrolyte additive may be present at a concentration of about 5 wt % or less. For example, the electrolyte additive when present, may be present at a concentration of about 0.1 wt % to about 5 wt %, about 1 wt % to about 5 wt %, or about 0.5 wt % to about 3 wt %.

As noted above, the anode includes lithium metal. This may be present in the form of a foil, sheet, sand, or other metallic form. In some embodiments, the anode includes lithium metal foil. In addition, silicon or conductive carbon materials may be included in the anode. In some embodiments, the conductive carbon is carbon nanotubes, carbon fiber, microporous carbon, mesoporous carbon, macroporous carbon, mesoporous microbeads, graphite, expandable graphite, polymer yield carbon, or carbon black. The metal of the anode may be the current collector, or the anode may also include a current collector.

The electrochemical devices also include a cathode. The cathode may include oxygen (O₂), in some embodiments. In other embodiments, the cathode may include a metal oxide which may be, but is not limited to, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}E′₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; E′ is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and l is greater than 0. In some embodiments, the metal oxide includes Li_{1+W}MnₓNi_{y}Co_{z}O₂ wherein w, x, y, and z satisfy the relations 0<w<1, 0≤x<1, 0≤y<1, 0≤z<1, and x+y+z=1. In some embodiments, the metal oxide includes LiMnₓNi_{y}O₄ wherein x and y satisfy the 0≤x<2, 0≤y<2, and x+y=2. In some embodiments, the positive electrode includes LiMnₓNi_{y}O₄ wherein x and y satisfy the 0≤x<2, 0≤y<2, and x+y=2. In some embodiments, the positive electrode includes xLi₂MnO₃·(1−x)LiMO₂ is wherein 0≤x<2. In some embodiments, the cathode includes a metal oxide that is LiMn_{0.5}Ni_{0.5}O₂, LiCoO₂, LiNiO₂, LiNi₁₋ₓCo_{y}Mn_{z}O₂, or a combination of any two or more thereof. In one embodiment, the cathode includes a metal oxide that is LiCoO₂ (lithium cobalt oxide). In one embodiment, the cathode includes a metal oxide that is LiFePO₄ (lithium iron phosphate oxide (LFP)). In some embodiments, the metal oxide is a lithium nickel manganese cobalt oxide (NMC). For example, the cathode may include a metal oxide that is LiNi_{α}Mn_{β}Co₆₅O₂, NMC111 (LiNi_{0.33}Co_{0.33}Mn_{0.33}O₂), NMC532 (LiNi_{0.5}Co_{0.2}Mn_{0.3}O₂), NMC622 (LiNi_{0.6}Co_{0.2}Mn_{0.2}O₂), NMC811 (LiNi_{0.8}Co_{0.1}Mn_{0.1}O₂) or a Ni-rich layer material such as Li_{1+x′}NiₕMnₖCoₗMe²_{y′}O_{2-z′}F_{z′} where 0≤h≤1. In some embodiments, the cathode comprises LiMn_{0.5}Ni_{0.5}O₂, LiCoO₂, LiNiO₂, LiNi₁₋ₓCo_{y}Mn_{z}O₂, or a combination of any two or more thereof, wherein 0≤x≤0.3; 0≤y≤0.5; 0≤z≤0.5.

The term “spinel” refers to a manganese-based spinel such as, Li₁₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5.

The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0.5.

The cathode may be further stabilized by surface coating the active particles with a material that can neutralize acid or otherwise lessen or prevent leaching of the transition metal ions. Hence, the cathodes may also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The coating can be applied to a carbon coated cathode.

The cathode may be further stabilized by surface coating the active particles with polymer materials. Examples of polymer coating materials include, but not limited to, polysiloxanes, polyethylene glycol, or poly(3,4-ethylenedioxythiophene) polystyrene sulfonate, a mixture of any two or more polymers.

The electrodes of the electrochemical cells (i.e. the lithium batteries) may also include a current collector. Current collectors for either the anode or the cathode may include those of copper, stainless steel, titanium, tantalum, platinum, gold, aluminum, nickel, cobalt, cobalt nickel alloy, highly alloyed ferritic stainless steel containing molybdenum and chromium; or nickel-, chromium-, or molybdenum containing alloys.

The electrodes (i.e., the cathode and/or the anode) may also include a conductive polymer as a binder. Illustrative conductive polymers include, but not limited to, polyaniline, polypyrrole, poly(pyrrole-co-aniline), polyphenylene, polythiophene, polyacetylene, polysiloxane, polyvinylidene difluoride, or polyfluorene.

The electrochemical cells disclosed herein may also include a porous separator to separate the cathode from the anode and prevent, or at least minimize, short-circuiting in the device. The separator may be a polymer or ceramic or mixed separator. The separator may include, but is not limited to, polypropylene (PP), polyethylene (PE), trilayer (PP/PE/PP), or polymer films that may optionally be coated with alumina-based ceramic particles.

As an example of the electrochemical cells described herein are lithium secondary batteries. The lithium secondary batteries described herein may find application as a lithium battery or a lithium-air battery.

The present invention, thus generally described, will be understood more readily by reference to the following examples, which are provided by way of illustration and are not intended to be limiting of the present invention.

### EXAMPLES

Example 1. A Li∥Li symmetric cell was prepared by is assembled with lithium metal as both counter and reference electrode in an argon atmosphere glovebox (<1 ppm of O₂ and H₂O). The charging/discharging rate was 2 mAhcm⁻². The electrolyte was (A) 1.2 M LiPF₆ in a terminally fluorinated diethylene glycol ether (FDG, 100%) and (B) a mixture of 1.2M LiPF₆ in a 3:7 (wt/wt) ratio of ethylene carbonate to ethylmethyl carbonate (“Gen2”). For clarity, the structure of terminally fluorinated diethylene glycol ether (FDG) used is:

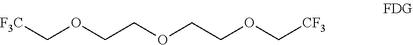 [SMILES: FC(F)(F)COCCOCCOCC(F)(F)F]

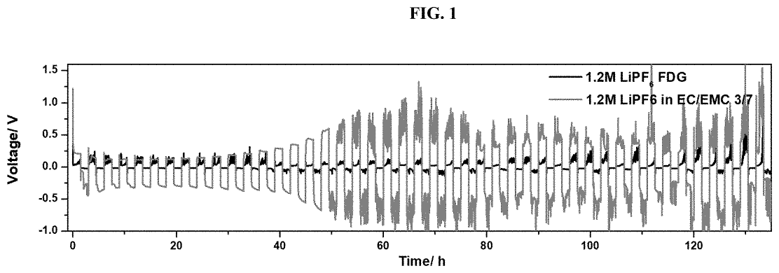

Example 2. Cycling of the cells prepared in Example 1. The cells prepared above in Example 1 were cycled at a current density of 2 mAcm². As illustrated in FIG. 1, the charge/discharge voltage stabilized within ±0.5 V for the cells using the 1.2M LiPF₆ in FDG electrolyte (A), while the charge/discharge voltages for conventional 1.2M LiPF₆ in EC/EMC (Gen2) electrolyte was large (>±1.5 V) and highly fluctuating. These results clearly show that electrolyte (A) enables a much more stable lithium plating and stripping than the Gen2 electrolyte.

Example 3. Li∥Li symmetric cells were prepared as in Example 1, but with (A) 1.2M LiPF₆ in FDG, and (B) 1.2M LiPF₆ in terminally fluorinated tetraethylene glycol ether (FTeG), i.e. a longer-chain terminally fluorinated glycol ether than FDG, and (C) lithium bis(fluoromethanesulfonyl)imide (LiFSI) in FDG in a LiFSI:FDG molar ratio of 1:3 (this equates to approximately 2 M). This example illustrates the stability difference when the PF₆ salt is used compared to the fluorinated sulfonylimide.

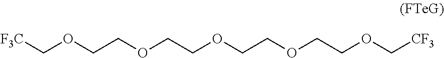 [SMILES: FC(F)(F)COCCOCCOCCOCCOCC(F)(F)F]

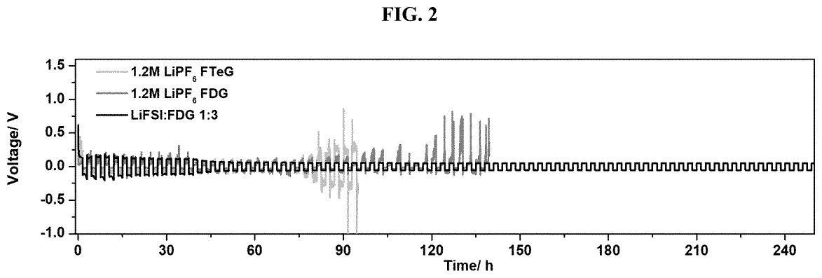

Example 4. Cycling of the cells prepared in Example 3. The cells prepared above in Example 3 were cycled at a current density of 2 mAcm². As illustrated in FIG. 2 a graph of cycling performance is provided for the cells using the different electrolytes. The cycling performance of the cell using the FDG was clearly superior to that of the cell using FTeG, of which the charge/discharge voltages were large and highly fluctuating. More importantly, the charge/discharge voltage of the cell using electrolyte (C) LiFSI:FDG 1:3 molar ratio was highly stable with charge/discharge voltage stabilized within ±0.1 V after 20 cycles, demonstrating the synergistic effect of LiFSI salt and short chain terminally fluorinated glycol ether.

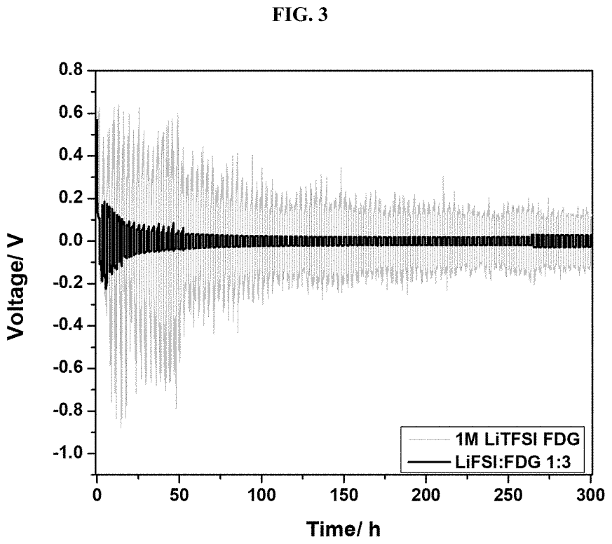

Example 5. symmetric cells were prepared as in Example 1, but with LiFSI in FDG (1:3 molar ratio) and 1M LiTFSI in FDG. The cells were then cycled at a current density of 2 mAcm². As illustrated in FIG. 3 a graph of cycling performance is provided for the cells using the two different electrolytes. The cycling performance of the cell using LiTFSI-based electrolyte with FDG solvent was clearly better than cell using LiPF₆ based electrolyte as evidenced by the smaller charge/discharge voltage fluctuation. The cycling performance of the cell using LiFSI in FDG was clearly superior to both the cells using LiPF₆ and LiTFSI based electrolytes, however, LiTFI may find use as a co-salt with the LFSI.

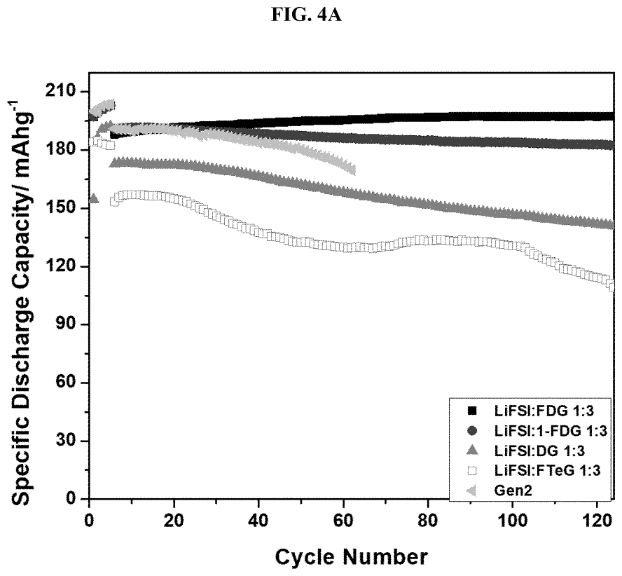

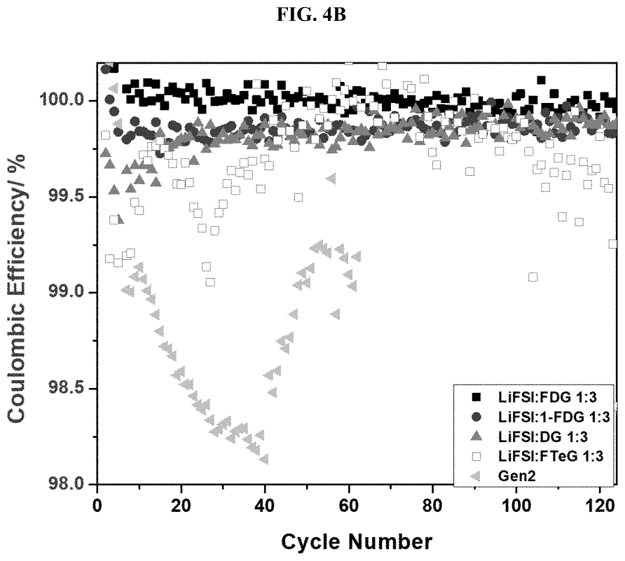

Example 6. 2032 coin cells of Li∥NMC811 (LiNi_{0.8}Mn_{0.1}Co_{0.1}O₂) were prepared with an NMC811 positive electrode (1.93 mAh cm⁻² areal capacity), a foil of Li metal anode, one piece of separator (Celgard 2325), and the prepared electrolyte (30 μL in each cell). The Li∥NMC811 cells were prepared in an argon atmosphere glovebox (<1 ppm of O₂ and H₂O). The electrolytes included those as used in Examples 1 and 3 as Gen2 and (C); as well as LiFSI in (E) one-sided terminally fluorinated diethylene glycol ether (1-FDG), (F) diglyme (DG), and (G) longer chain terminally fluorinated tetraethylene glycol ether (FTeG) using an 1:3 molar ratio. The coin cells were cycled between 2.5 V to 4.3 V. As depicted in FIGS. 4A and 4B, the cycling performance of the Li∥NMC811 cells illustrates that the capacity of the cell with the conventional (“Gen2”) electrolyte decayed rapidly within 60 cycles due to lithium dendrite formation. Meanwhile, the cell employing non-fluorinated DG electrolyte displayed relatively low specific capacity and Coulombic efficiency with fast capacity fading. Moreover, the Li∥NMC811 cell using longer chain terminally fluorinated tetraethylene glycol ether (FTeG) presented even lower specific capacity and Coulombic efficiency than the DG cell, while the Li∥NMC811 cell employing one-sided terminally fluorinated diethylene glycol ether (1-FDG) electrolyte showed enhanced specific capacity, capacity retention, and Coulombic efficiency. This indicates that there is a synergistic effect of lithium fluorosulfonylimide salt with short-chain terminally fluorinated glycol ethers. Further, the cell using short chain terminally fluorinated diethylene glycol ether (FDG) with fluorinated group at both terminals displayed the best cycling performance with exceptional capacity retention and Coulombic efficiency.

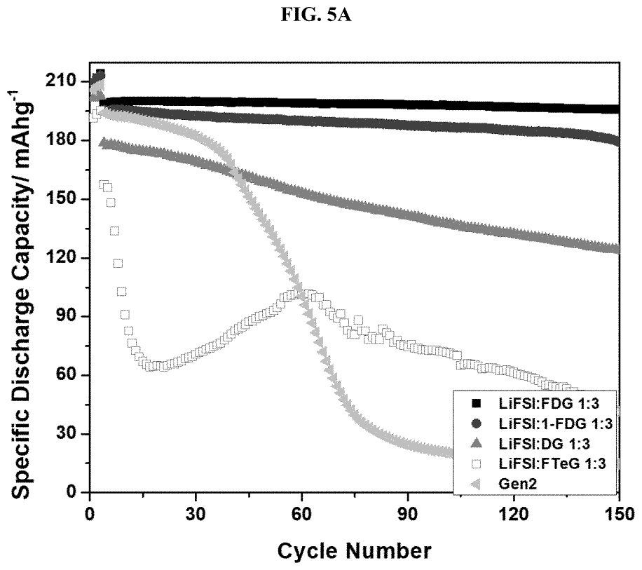

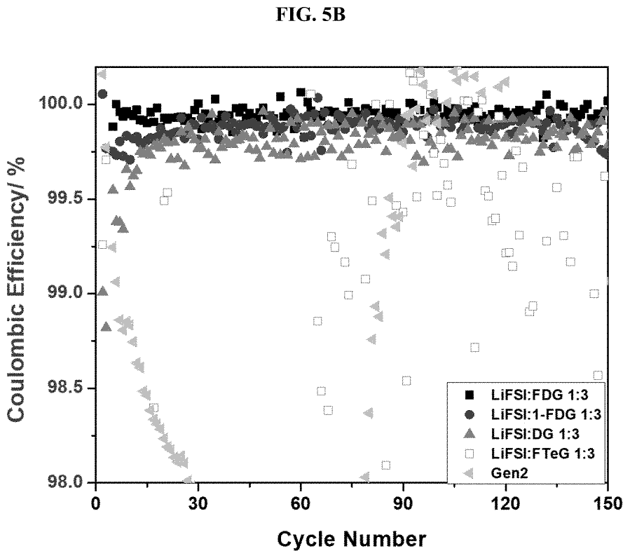

Example 7. 2032 coin cells of Li∥NMC811 were prepared as in Example 6, but with operational voltage between 3.0 V to 4.4 V. With a higher upper cutoff voltage, the difference in cycling performance was amplified. As displayed in FIGS. 5A and 5B, the capacity of Li∥NMC811 cell using conventional electrolyte Gen2 dropped rapidly to <20% within 70 cycles. The rate of capacity fade for the cell using non-fluoroinated DG based electrolyte was significantly enhanced. The specific capacity of the Li∥NMC811 cell employing FTeG electrolyte dropped below 100 mAh/g within the 10 cycles, which again demonstrated the ineffectiveness of longer chain terminally fluorinated glycol ether. Comparatively, the Li∥NMC811 cell using the one-sided terminally fluorinated diethylene glycol ether (1-FDG) electrolyte again exhibited enhanced specific capacity, capacity retention, and Coulombic efficiency, while the cell using short chain terminally fluorinated diethylene glycol ether (FDG) with fluorinated group at both terminals displayed the best cycling performance again. These results clearly support the synergistic effect of lithium fluorosulfonylimide salt with a short-chain terminally fluorinated glycol ether.

The electrochemical performance of the lithium battery using a short-chain terminally fluorinated glycol ether as the electrolyte solvent is significantly better than those cells using an unfluorinated glycol ether or a fluorinated glycol ether with a longer chain length. In addition, the use of a lithium fluorosulfonylimide salt (e.g., LiFSI) coupled with a short-chain terminally fluorinated glycol ether offers a profound synergistic effect on the stabilization of lithium metal batteries.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising oxygen or a metal oxide;
an anode comprising lithium metal;
a separator; and
an electrolyte comprising:
a lithium fluorinated sulfonylimide salt;
a terminally fluorinated glycol ether of Formula (I);
R¹(O(CH₂)ₘ)ₓ(O(CH₂)ₙ)_{y}OR² (I);
wherein:
R¹ is a fluorinated alkyl;
R² is a fluorinated alkyl;
m is 1, 2, or 3; and
x and y are each independently 0, 1, or 2, with the provisos that both x and y are not 0 and x+y≤3;
and optionally an electrolyte additive, an aprotic gel polymer, or a mixture thereof.

2. The electrochemical cell of claim 1, wherein the cathode comprising a metal oxide is selected from a lithium nickel manganese cobalt oxide (NMC), a lithium cobalt oxide (LCO), and a lithium iron phosphate oxide (LFP).

3. The electrochemical cell of claim 1, wherein the terminally fluorinated glycol ether is a short-chain terminally fluorinated glycol ether.

4. The electrochemical cell of claim 1, wherein the electrolyte comprises greater than 50 wt % of the terminally fluorinated glycol ether.

5. The electrochemical cell of claim 1, wherein the electrolyte consists essentially of the lithium sulfonylimide salt, the terminally fluorinated glycol ether, and optionally the electrolyte additive.

6. The electrochemical cell of claim 1, wherein the anode further comprises silicon, a conductive carbon, or a combination of any two or more thereof

7. The electrochemical cell of claim 1, wherein at least one of R¹ and R² is a fluorinated alkyl having at least two fluorine atoms.

8. The electrochemical cell of claim 1, wherein at least one of R¹ and R² is a fluorinated alkyl having at least three fluorine atoms.

9. The electrochemical cell of claim 1, wherein
R¹ is —(CH₂)_{q}(CR⁴R⁵)ₚC(R³)₃;
R² is —(CH₂)ᵥ(CR^{4′}R^{5′})_{w}C(R^{3′})₃;
R³, R⁴, and R⁵ are each independently H or F, with the proviso that at least one of R³, R⁴, and R⁵ is F;
R^{3′}, R^{4′}, and R^{5′} are each independently H or F, with the proviso that at least one of R^{3′}, R^{4′}, and R^{5′} is F;
q is 0, 1, 2, or 3;
p is 0, 1, 2, 3, 4, 5, or 6;
v is 0, 1, or 2; and
w is 0, 1, 2, 3, 4, 5, or 6.

10. The electrochemical cell of claim 9, wherein
y is 0; and
x is 2.

11. The electrochemical cell of claim 10, wherein
R³ is F;
R⁴ and R⁵ are H;
q is 1 or 2; and
p is O.

12. The electrochemical cell of claim 1, wherein the terminally fluorinated glycol ether is:

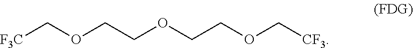 [SMILES: FC(F)(F)COCCOCCOCC(F)(F)F]

13. The electrochemical cell of claim 1, wherein the anode comprises a lithium metal foil, sheet, or sand.

14. The electrochemical cell of claim 1, wherein the anode comprises a lithium metal foil.

15. The electrochemical cell of claim 1, wherein the lithium fluorinated sulfonylimide salt comprises LiN(SO₂F)₂; LiN(SO₂CF₃)₂; LiN(SO₂C₂F₅)₂; Li(SO₂F)N(SO₂CF₃);
Li(SO₂F)N(SO₂CH₃); Li(SO₂F)N(SO₂C₂H₅); Li(SO₂F)N(SO₂C₂F₅);
Li(SO₂F)N(SO₂CHF₂); Li(SO₂F)N(SO₂CH₂F); Li(SO₂F)N(SO₂CH₂CF₃);
Li(SO₂F)N(SO₂CH₂CHF₂); Li(SO₂F)N(SO₂CHFCH₃); Li(SO₂F)N(SO₂CHFCF₃);
Li(SO₂F)N(SO₂CHFCHF₂); Li(SO₂F)N(SO₂CHFCH₂F); Li(SO₂F)N(SO₂CF₂CH₃);
Li(SO₂F)N(SO₂CF₂CF₃); Li(SO₂F)N(SO₂CF₂CHF₂); Li(SO₂F)N(SO₂CF₂CH₂F);
Li(SO₂CF₃)N(SO₂CH₃); Li(SO₂CF₃)N(SO₂CHF₂); Li(SO₂CF₃)N(SO₂CH₂F);
Li(SO₂CF₃)N(SO₂CH₂CF₃), or a mixture of any two or more thereof.

16. The electrochemical cell of claim 15, wherein the lithium fluorinated sulfonylimide salt comprises LiN(SO₂F)₂.

17. The electrochemical cell of claim 1, wherein the the electrolyte additive is present and comprises LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ); Li₂(B₁₀X_{10-i′}H_{i′}), or a mixture of any two or more thereof;
wherein each X is independently a halogen, each i is an integer from 0 to 12 and each i′ is an integer from 0 to 10.

18. The electrochemical cell of claim 1, wherein the electrolyte additive is present at a concentration of less than about 5 wt %.

19. The electrochemical cell of claim 1, wherein the aprotic gel polymer is present.

20. The electrochemical cell of claim 1 that is a lithium secondary battery or lithium-air battery.
